(19) United States
(12) Patent Application Publication
(10) Pub. No.: US 2015/0227261 A1
(43) Pub. Date: Aug. 13, 2015

(54) OPTICAL IMAGING SYSTEM AND IMAGING PROCESSING METHOD FOR OPTICAL IMAGING SYSTEM

(71) Applicant: Wistron Corporation, New Taipei City (TW)

(72) Inventors: Po-Liang Huang, New Taipei City (TW); Chun-Chieh Li, New Taipei City (TW); Chia-Chang Hou, New Taipei City (TW)

(21) Appl. No.: 14/450,290

(22) Filed: Aug. 4, 2014

(30) Foreign Application Priority Data
Feb. 7, 2014 (TW) 103104085

(51) Int. Cl. G06F 3/042; G06F 3/0354

(52) U.S. Cl. CPC G06F 3/0421; G06F 3/03545; G06F 2203/04104

(57) ABSTRACT

An optical imaging system includes a display panel, a light source module, a first touch object, a second touch object, an image capturing module and a control module. A first reflective section of the first touch object and a second reflective section of the second touch object have different reflectivities. The image capturing module captures light reflected from the first reflective section of the first touch object and the second reflective section of the second touch object, so as to generate a first signal corresponding to the first touch object and a second signal corresponding to the second touch object. The first signal and the second signal have different waveforms. The control module calculates coordinate values of the first touch object and the second touch object according to the first signal and the second signal.

### BACKGROUND OF THE INVENTION

1. Field of the Invention

The present invention is to provide an optical imaging system and an imaging processing method for the optical image system, and more specifically, to an optical imaging system and an imaging processing method capable of recognizing a plurality of touch objects simultaneously.

2. Description of the Prior Art

In the modern consumer electronic products, a portable electronic product such as a personal digital assistant, a smart phone or a mobile phone is equipped with a touch control device as an interface for data transmission. Since consumer electronic products have become lighter, thinner, shorter and smaller, there is no space on these products for containing a conventional input device, such as a mouse, a keyboard and so on. Furthermore, with development of tablet computers focusing on humanity design, a display with the touch control device has gradually become one of the key components in various electronic products. A variety of touch control technologies, such as a resistive type, a capacitive type, an ultrasonic type, an infrared type, an optical imaging type and so on have been developing. Due to consideration for technology level and cost, the above-mentioned touch control technologies have been implemented in various fields.

For example, principle of the optical imaging design is to utilize two image capturing modules located at two corners of the display for detecting a position of an object on the display. Then, the position of the object on the display is calculated by triangulating location. Thus, compared with the conventional resistive type or capacitive type touch device, it has advantages of accuracy, high penetration, good stability, low damage rate, low cost and being capable of multi-touch, and the optical imaging design is overwhelmingly advantageous in the large-size display market. However the conventional optical imaging touch device needs a reflecting frame as a photographic background when the object is located within a coordinate detecting area, to isolate interference outside the coordinate detecting area. The object blocks the light reflected from the reflecting frame as locating within the coordinate detecting area so as to detect a shadow by a sensor, for getting the position of the object by the position of the shadow. In other words, the reflecting frame provides the function of blocking the interference and difference between the object and the background. However, the reflecting frame and the sensor have to be installed on the same plane, resulting in difficulty in assembly and increasing manufacturing cost. Furthermore, as utilizing a plurality of fingers or styluses at the same time in the conventional optical imaging touch device, different blocking signals detected by sensors and generated from different touch objects are unrecognizable, so that the conventional optical image system cannot recognize individual finger or stylus from others. For example, as applying two styluses with different colors in education, that is a student can answer with a blue stylus and a teacher reviews with a red stylus, the conventional optical image system cannot recognize the styluses with different colors, resulting in limitation of practical application.

### SUMMARY OF THE INVENTION

The present invention is to provide an optical imaging system and an imaging processing method capable of recognizing a plurality of touch objects simultaneously to solve the above drawbacks.

According to the disclosure, an optical imaging system capable of recognizing a plurality of touch objects includes a display panel, a light source module, a first touch object, a second touch object, an image capturing module and a control module. A coordinate detecting area is formed on the display pane. The light source module is disposed on an outer side of the display panel and for emitting light. The first touch object includes a first reflective section for reflecting the light emitted from the light source module as moving in the coordinate detecting area. The second touch object includes a second reflective section for reflecting the light emitted from the light source module as moving in the coordinate detecting area, and the first reflective section and the second reflective section have different reflectivities. The image capturing module is disposed on an outer side of the display panel and for capturing light reflected from the first reflective section so as to generate a first signal corresponding to the first touch object, and the image capturing module is further for capturing light reflected from the second reflective section so as to generate a second signal corresponding to the second touch object, wherein the first signal and the second signal have different waveforms. The control module is coupled to the image capturing module and for calculating coordinate values of the first touch object and the second touch object on the coordinate detecting area according to the first signal and the second signal.

According to the disclosure, all of the first reflective section of the first touch object is made of reflective material, and a part of the second reflective section of the second touch object is made of reflective material and the other part of the second reflective section of the second touch object is made of non-reflective material.

According to the disclosure, a plurality of transparent bead structures is formed on the first reflective section of the first touch object, a plurality of banding transparent bead structures and a plurality of banding non-beaded structures are formed on the second reflective section of the second touch object, the plurality of transparent bead structures and the plurality of banding transparent bead structures reflect the light emitted from the light source module, and the plurality of banding non-beaded structures does not reflect the light emitted from the light source module.

According to the disclosure, a plurality of prism structures is formed on the first reflective section of the first touch object, a plurality of banding prism structures and a plurality of banding non-prism structures are formed on the second reflective section of the second touch object, the plurality of prism structures and the plurality of banding prism structures reflect the light emitted from the light source module, and the plurality of banding non-prism structures does not reflect the light emitted from the light source module.

According to the disclosure, reflective substances with different densities or different numbers are respectively formed on the first reflective section and the second reflective section.

According to the disclosure, each reflective substance is a transparent bead structure or a prism structure.

According to the disclosure, the first touch object and the second touch object are styluses.

According to the disclosure, the first touch object and the second touch object respectively include a penholder, and the first reflective section and the second reflective section are detachably connected to the penholders.

According to the disclosure, the first signal includes a non-notched pulse and the second signal includes a notched pulse.

According to the disclosure, the light source module includes two light emitting diodes respectively disposed on two outer corners of the display panel, and the image capturing module includes two image sensors respectively disposed on the two outer corners of the display panel.

According to the disclosure, an imaging processing method for recognizing a plurality of touch objects includes forming a first reflective section on a first touch object and a second reflective section on a second touch object, wherein the first reflective section and the second reflective section have different reflectivities, a light source module emitting light to the first touch object and the second touch object, the image capturing module respectively capturing light reflected from the first reflective section and the second reflective section so as to generate a first signal corresponding to the first touch object and a second signal corresponding to the second touch object, wherein the first signal and the second signal have different waveforms, and the control module calculating a coordinate value of the first touch object according to the first signal and a coordinate value of the second touch object according to the second signal.

According to the disclosure, forming the first reflective section on the first touch object and the second reflective section on the second touch object includes forming all of the first reflective section made of reflective material, and forming apart of the second reflective section made of reflective material and the other part of the second reflective section made of non-reflective material.

According to the disclosure, forming the first reflective section on the first touch object and the second reflective section on the second touch object includes forming reflective substances with different densities or different numbers of reflective substances on the first reflective section and the second reflective section.

According to the disclosure, the control module calculating the coordinate value of the first touch object according to the first signal and the coordinate value of the second touch object according to the second signal includes the control module calculating the coordinate value of the first touch object according to the first signal having a non-notched pulse and the coordinate value of the second touch object according to the second signal having a notched pulse.

The recognition of the plurality of touch objects can be performed by utilizing the optical imaging system and the imaging processing method of the present invention. The plurality of touch objects with different reflectivities generates the corresponding signals with different waveforms. Hence, the corresponding touch objects can be determined according to the signals with different waveforms, so as to expand practical application of the optical imaging system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an optical imaging system according to an embodiment of the present invention.

FIG. 2 is a front view of the optical imaging system according to the embodiment of the present invention.

FIG. 3 and FIG. 4 are schematic diagrams of a first touch object and a second touch object according to the embodiment of the present invention.

FIG. 5 is a flow chart of an imaging processing method by utilizing the optical imaging system according to the embodiment of the present invention.

FIG. 6 is a waveform diagram of a first signal and a second signal according to the embodiment of the present invention.

### DETAILED DESCRIPTION

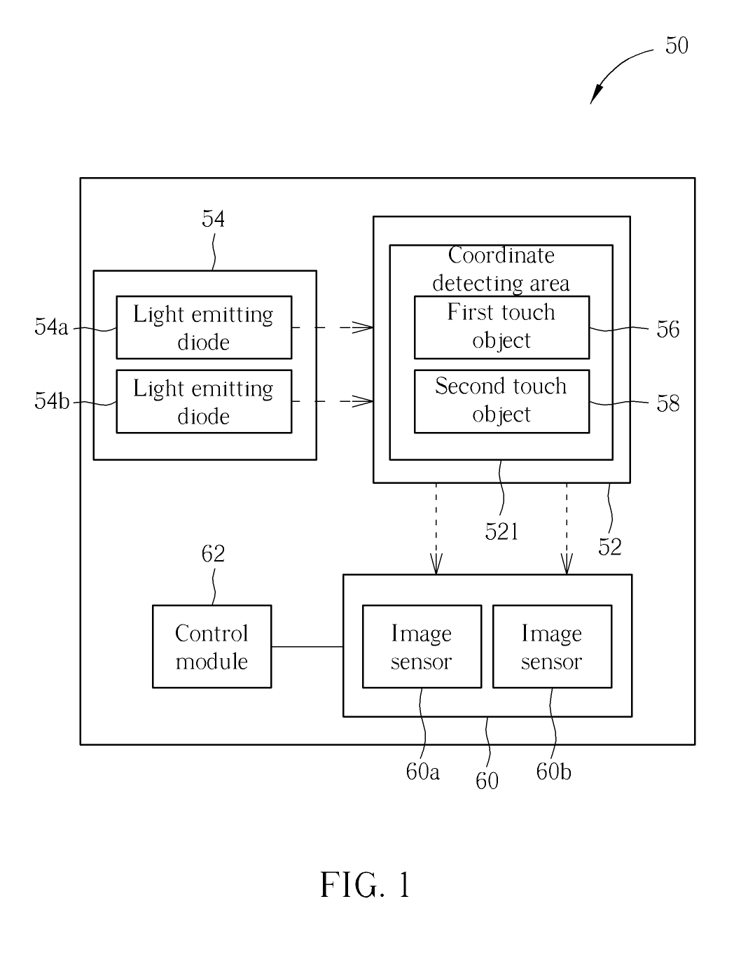

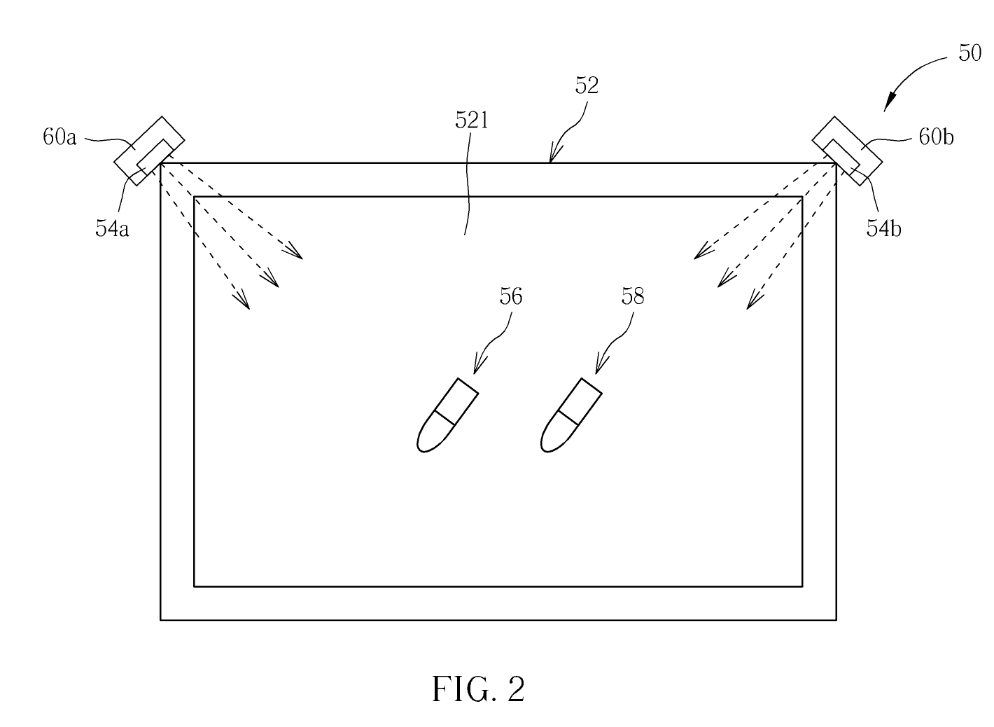

Please refer to FIG. 1 and FIG. 2. FIG. 1 is a functional block diagram of an optical imaging system 50 according to an embodiment of the present invention. FIG. 2 is a front view of the optical imaging system 50 according to the embodiment of the present invention. The optical imaging system 50 is capable of recognizing a plurality of touch objects. The optical imaging system 50 includes a display panel 52, a light source module 54, a first touch object 56, a second touch object 58, an image capturing module 60 and a control module 62. The display panel 52 can be a touch panel, and a coordinate detecting area 521 is formed on the display panel 52. The light source module 54 is disposed on an outer side of the display panel 52 for emitting light. In this embodiment, the light source module 54 can include two light emitting diodes (LEDs) 54a, 54b, such as laser LEDs or infrared LEDs, and the LEDs 54a, 54b are disposed on two outer corners of the display module, respectively. The LEDs 54a, 54b are for emitting the light so as to illuminate the first touch object 56 and the second touch object 58. The image capturing module 60 is disposed on an outer side of the display panel 52 and for capturing light reflected from the first touch object 56 so as to generate a first signal corresponding to the first touch object and for capturing light reflected from the second touch object 58 so as to generate a second signal corresponding to the second touch object 58. In this embodiment, the image capturing module 60 can include two image sensors 60a, 60b respectively disposed on the two outer corners of the display panel 52 adjacent to the LEDs 54a, 54b. The control module 62 is coupled to the image capturing module 60 and for calculating coordinate values of the first touch object 56 and the second touch object 58 on the coordinate detecting area 521 according to the first signal and the second signal. In addition, the display panel 52, the light source module 54, the light capturing module 60 and the control module 62 can be integrated in a single display, such as a monitor or an All in One PC. Alternatively, the light source module 54, the image capturing module 60 and the control module 62 can be modularized separately, such as being disposed inside a frame hung on the display panel 52, and the coordinate detecting area 521 can be a transparent panel disposed on the frame so as to be installed on the different display panels 52.

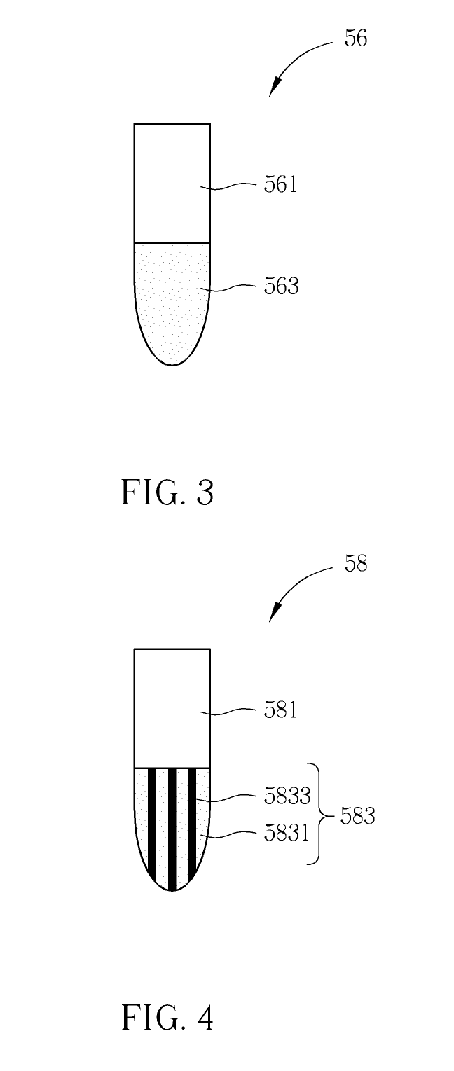

Please refer to FIG. 3 and FIG. 4. FIG. 3 and FIG. 4 are schematic diagrams of the first touch object 56 and the second touch object 58 according to the embodiment of the present invention. The first touch object 56 and the second touch object 58 can be styluses, and the first touch object 56 and the second touch object 58 respectively include penholders 561, 581. The first touch object 56 includes a first reflective section 563, and the second touch object 58 includes a second reflective section 583. The first reflective section 563 and the second reflective section 583 have different reflectivities. For example, the first reflective section 563 of the first touch object 56 can be made of reflective material, and a part of the second reflective section 583 of the second touch object 58 can be made of reflective material and the other part of the second reflective section 583 of the second touch object 58 can be made of non-reflective material. The reflective material can be a transparent bead structure or a prism structure. A part of the second reflective section 583 is made of non-reflective material, and the other part of the second reflective section 583 is made of reflective material, thus reflectability of the second reflective section 583 remains, and the reflectivities of the second touch object 58 can be different from the reflectivities of the first touch object 56.

For example, a plurality of transparent bead structures can be formed on the first reflective section 563 of the first touch object 56, and a plurality of banding transparent bead structures 5831 and a plurality of banding non-beaded structures 5833 can be formed on the second reflective section 583 of the second touch object 58. The plurality of banding transparent bead structures 5831 and the plurality of banding non-beaded structures 5833 can be disposed in intervals. The plurality of transparent bead structures and the plurality of banding transparent bead structures 5831 can reflect the light emitted from the light source module 54 back along an original incident path, and the plurality of banding non-beaded structures 5833 does not reflect the light emitted from the light source module 54. In another embodiment, reflective substances with different densities or different numbers can be respectively formed on the first reflective section 563 and the second reflective section 583. In conclusion, all applications including the first reflective section 563 disposed on the first touch object 56 and the second reflective section 583 disposed on the second touch object 58 with different reflectivities are within the scope of the present invention. In addition, the first reflective section 563 and the second reflective section 583 can be detachably connected to the penholders 561, 581, so as to adjust the reflectivities of the first touch object 56 and the second touch object 58 more flexibly.

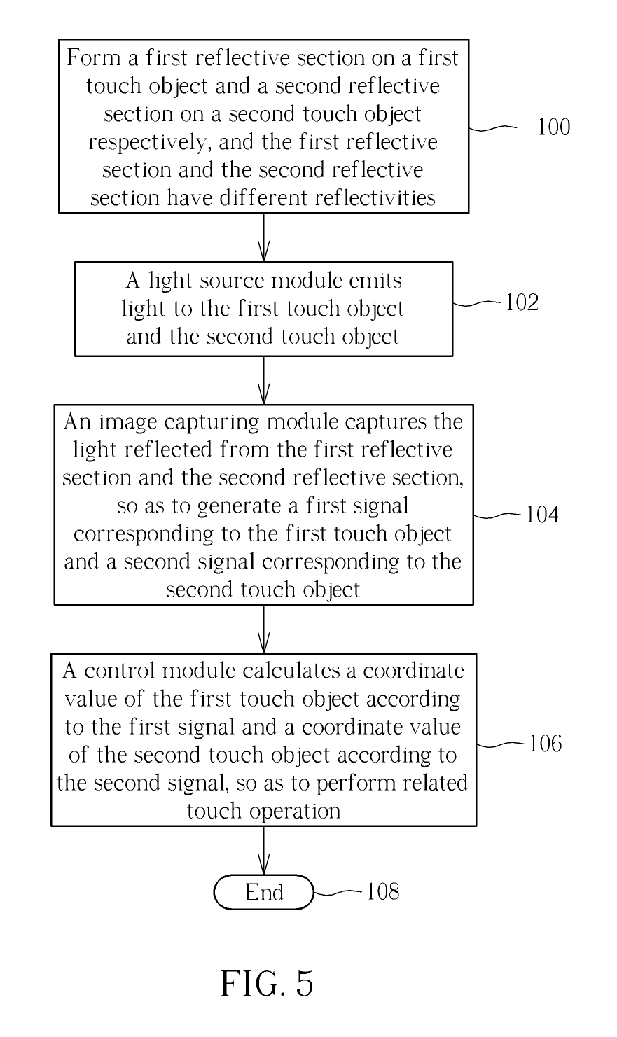

Please refer to FIG. 5. FIG. 5 is a flow chart of an imaging processing method by utilizing the optical imaging system 50 according to the embodiment of the present invention. The imaging processing method includes the following steps:

Step 100: Form the first reflective section 563 on the first touch object 56 and the second reflective section 583 on the first touch object 58 respectively, and the first reflective section 563 and the second reflective section 583 have different reflectivities.

Step 102: The light source module 54 emits light to the first touch object 56 and the second touch object 58, as the first touch object 56 and the second touch object 58 operate in the coordinate detecting area 521.

Step 104: The image capturing module 60 captures the light reflected from the first reflective section 563 and the second reflective section 583, so as to generate a first signal corresponding to the first touch object 56 and a second signal corresponding to the second touch object 58, and the first signal and the second signal have different waveforms.

Step 106: The control module 62 calculates a coordinate value of the first touch object 56 according to the first signal and a coordinate value of the second touch object 58 according to the second signal, so as to perform related touch operation.

Step 108: End.

Detailed introduction of the above steps is described as follows. A user can operate the first touch object 56 and the second touch object 58 on the coordinate detecting area 521. As the first touch object 56 and the second touch object 58 move close to the coordinate detecting area 521, the light source module 54 emits the light to the first touch object 56 and the second touch object 58 so as to illuminate the first touch object 56 and the second touch object 58. And then, the image capturing module 60 respectively captures the light reflected from the first reflective section 563 and the second reflective section 583. Because the first reflective section 563 and the second reflective section 583 have different reflectivities, the image capturing module 60 receives different light signals from the first reflective section 563 and the second reflective section 583, so as to generate the first signal corresponding to the first touch object 56 and the second signal corresponding to the second touch object 58, and the first signal and the second signal have different waveforms.

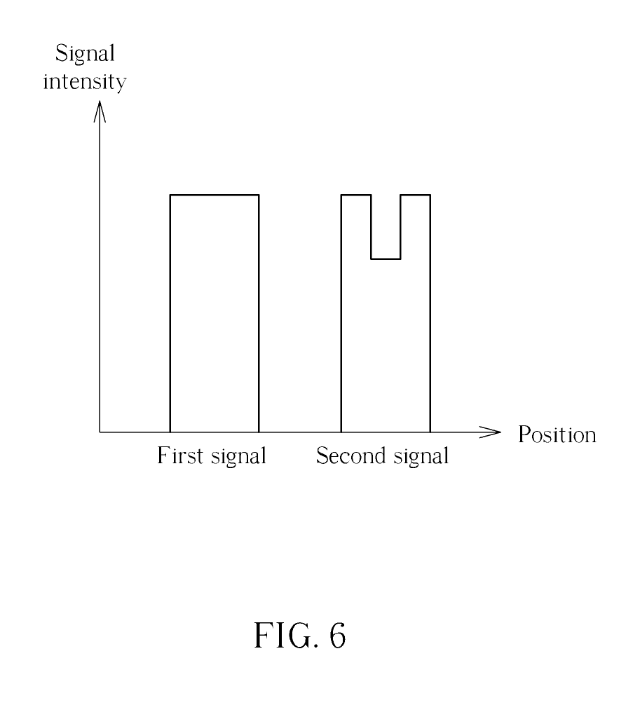

Please refer to FIG. 6. FIG. 6 is a waveform diagram of the first signal and the second signal according to the embodiment of the present invention. For example, because the first reflective section 563 of the first touch object 56 can be covered with the transparent bead structures or the prism structures which are reflective, the light emitted from the LEDs 54a, 54b can be totally reflected by the first reflective section 563 to the corresponding image sensor 60a, 60b back along the original incident path, so as to generate a non-notched pulse in the first signal. However, the second reflective section 583 of the second touch object 58 includes a part of the banding transparent bead structures 5831 and a part of the banding non-bead structures 5833, or the second reflective section 583 includes a part of the banding prism structures and a part of the banding non-prism structures. The banding non-bead structures 5833 and the banding non-prism structures are not reflective and cannot reflect the light to the corresponding image sensor 60a, 60b, so as to generate a notched pulse in the second signal.

Accordingly, the control module 62 determines the first touch object 56 and the second touch object 58 according to the waveform difference between the first signal and the second signal, so as to respectively calculate coordinate values of the first touch object 56 and the second touch object 58. For example, the control module 62 can perform image processing analysis for the image information first, such as noise reduction, and then perform coordinate transformation of the processed image information, such as getting the position of the first touch object 56 and the second touch object 58 according to the included angles between the captured images by the image sensor 60a, 60b and axes by triangulating location, so as to get the corresponding coordinate values of the first touch object 56 and the second touch object 58 and provide the host computer with a basis to perform the related touch operation. For example, the first touch object 56 and the second touch object 58 can be applied in education. The first touch object 56 and the second touch object 58 can be styluses with different color, such as a blue stylus and a red stylus. A student answers with the blue stylus and a teacher reviews with the red stylus simultaneously. Besides, more touch objects can be provided, and the present invention is not limited to the image processing method of utilizing the first touch object 56 and the second object 58. A plurality of styluses with different reflectivities can be provided, the styluses are respectively corresponding to signals with different waveforms, and the control module 62 determines the corresponding touch objects according to the signals with different waveforms. Hence, the practical application of the optical imaging system and the image processing method can be utilized widely. Furthermore, because of utilizing the image sensor to sense the reflected light, a reflecting frame is not necessary to apply in the optical imaging system and the imaging processing method of the present invention. Assembly of the optical imaging system can be simplified, and the manufacture cost can be reduced without reducing the accuracy of the touch operation.

In contrast to the prior art, the recognition of the plurality of touch objects can be performed by utilizing the optical imaging system and the imaging processing method of the present invention. The plurality of touch objects with different reflectivities generates the corresponding signals with different waveforms. Hence, the corresponding touch objects can be determined according to the signals with different waveforms, so as to expand practical application of the optical imaging system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical imaging system capable of recognizing a plurality of touch objects, the optical imaging system comprising:
a display panel whereon a coordinate detecting area is formed;
a light source module disposed on an outer side of the display panel and for emitting light;
a first touch object comprising a first reflective section for reflecting the light emitted from the light source module as moving in the coordinate detecting area;
a second touch object comprising a second reflective section for reflecting the light emitted from the light source module as moving in the coordinate detecting area, wherein the first reflective section and the second reflective section have different reflectivities;
an image capturing module disposed on an outer side of the display panel and for capturing light reflected from the first reflective section so as to generate a first signal corresponding to the first touch object, and the image capturing module being further for capturing light reflected from the second reflective section so as to generate a second signal corresponding to the second touch object, wherein the first signal and the second signal have different waveforms; and
a control module coupled to the image capturing module and for calculating coordinate values of the first touch object and the second touch object on the coordinate detecting area according to the first signal and the second signal.

2. The optical imaging system of claim 1, wherein all of the first reflective section of the first touch object is made of reflective material, and a part of the second reflective section of the second touch object is made of reflective material and the other part of the second reflective section of the second touch object is made of non-reflective material.

3. The optical imaging system of claim 1, wherein a plurality of transparent bead structures is formed on the first reflective section of the first touch object, a plurality of banding transparent bead structures and a plurality of banding non-beaded structures are formed on the second reflective section of the second touch object, the plurality of transparent bead structures and the plurality of banding transparent bead structures reflect the light emitted from the light source module, and the plurality of banding non-beaded structures does not reflect the light emitted from the light source module.

4. The optical imaging system of claim 1, wherein a plurality of prism structures is formed on the first reflective section of the first touch object, a plurality of banding prism structures and a plurality of banding non-prism structures are formed on the second reflective section of the second touch object, the plurality of prism structures and the plurality of banding prism structures reflect the light emitted from the light source module, and the plurality of banding non-prism structures does not reflect the light emitted from the light source module.

5. The optical imaging system of claim 1, wherein reflective substances with different densities or different numbers are respectively formed on the first reflective section and the second reflective section.

6. The optical imaging system of claim 5, wherein each reflective substance is a transparent bead structure or a prism structure.

7. The optical imaging system of claim 1, wherein the first touch object and the second touch object are styluses.

8. The optical imaging system of claim 1, wherein the first touch object and the second touch object respectively comprise a penholder, and the first reflective section and the second reflective section are detachably connected to the penholders.

9. The optical imaging system of claim 1, wherein the first signal comprises a non-notched pulse and the second signal comprises a notched pulse.

10. The optical imaging system of claim 1, wherein the light source module comprises two light emitting diodes (LEDs) respectively disposed on two outer corners of the display panel, and the image capturing module comprises two image sensors respectively disposed on the two outer corners of the display panel.

11. An imaging processing method for recognizing a plurality of touch objects, comprising:
forming a first reflective section on a first touch object and a second reflective section on a second touch object, wherein the first reflective section and the second reflective section have different reflectivities;
a light source module emitting light to the first touch object and the second touch object;
an image capturing module respectively capturing light reflected from the first reflective section and the second reflective section so as to generate a first signal corresponding to the first touch object and a second signal corresponding to the second touch object, wherein the first signal and the second signal have different waveforms; and
a control module calculating a coordinate value of the first touch object according to the first signal and a coordinate value of the second touch object according to the second signal.

12. The imaging processing method of claim 11, wherein forming the first reflective section on the first touch object and the second reflective section on the second touch object comprises forming all of the first reflective section made of reflective material, and forming a part of the second reflective section made of reflective material and the other part of the second reflective section made of non-reflective material.

13. The imaging processing method of claim 11, wherein forming the first reflective section on the first touch object and the second reflective section on the second touch object comprises forming reflective substances with different densities or different numbers of reflective substances on the first reflective section and the second reflective section.

14. The imaging processing method of claim 11, wherein the control module calculating the coordinate value of the first touch object according to the first signal and the coordinate value of the second touch object according to the second signal comprises the control module calculating the coordinate value of the first touch object according to the first signal having a non-notched pulse and the coordinate value of the second touch object according to the second signal having a notched pulse.
